(19) United States
(12) Patent Application Publication
(10) Pub. No.: US 2026/0036512 A1
(43) Pub. Date: Feb. 5, 2026

(54) SYSTEMS AND METHODS FOR SPECTROSCOPIC INSTRUMENT CALIBRATION

(71) Applicant: Thermo Electron Scientific Instruments LLC, Madison, WI (US)

(72) Inventor: Logan Wille, Madison, WI (US)

(21) Appl. No.: 19/099,931

(22) PCT Filed: Aug. 1, 2023
(86) PCT No.: PCT/US2023/071458

§ 371 Date: Jan. 30, 2025

Related U.S. Application Data
(60) Provisional application No. 63/394,553, filed on Aug. 2, 2022.

(51) Int. Cl. G01N 21/27

(52) U.S. Cl. CPC G01N 21/274; G01N 2201/12784

(57) ABSTRACT

Disclosed herein are scientific instrument support systems, as well as related methods, computing devices, and computer-readable media. For example, in some embodiments, a method of supporting spectroscopic calibration may include: generating a base calibration model using data from multiple base spectroscopic instruments, and finetuning the base calibration model using data from a target spectroscopic instrument to generate a target calibration model for use with the target spectroscopic instrument. In some embodiments, the number of wavelengths used in generating the base calibration model and/or the target calibration model may be less than the total number of wavelengths represented in the output of the spectroscopic instruments.

### RELATED APPLICATION

This application claims priority to U.S. Provisional Patent Application No. 63/394,553, filed Aug. 2, 2022, the entire content of which is incorporated by reference herein by in its entirety.

### BACKGROUND

Many scientific instruments require calibration, the association between the output of the scientific instrument and a known state or property. Spectroscopic instruments, for example, may output an intensity that is a function of a property of a sample, and the calibration of such spectroscopic instruments may specify a relationship between the output intensity and the sample property.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, not by way of limitation, in the figures of the accompanying drawings.

FIG. 1 is a flow diagram of a process for training a base model and creating a finetuned target model that may be used for calibration of a spectroscopic instrument, in accordance with various embodiments.

FIG. 2 illustrates a full spectrum of intensities and a sampling of that spectrum that may be used in a calibration model, in accordance with various embodiments.

FIGS. 3 and 4 illustrate example neural network model architectures that may be used for the base model and the target model, in accordance with various embodiments.

FIGS. 5A and 5B illustrate example performance results for the use of a base model and a finetuned target model, respectively, for calibrating spectroscopic instruments to recognize the amount of sulfur in metal samples, in accordance with various embodiments.

FIG. 6 is a block diagram of an example scientific instrument support module for performing support operations, in accordance with various embodiments.

FIG. 7 is a flow diagram of an example method of performing support operations, in accordance with various embodiments.

FIG. 8 is an example of a graphical user interface that may be used in the performance of some or all of the support methods disclosed herein, in accordance with various embodiments.

FIG. 9 is a block diagram of an example computing device that may perform some or all of the scientific instrument support methods disclosed herein, in accordance with various embodiments.

FIG. 10 is a block diagram of an example scientific instrument support system in which some or all of the scientific instrument support methods disclosed herein may be performed, in accordance with various embodiments.

### DETAILED DESCRIPTION

Disclosed herein are scientific instrument support systems, as well as related methods, computing devices, and computer-readable media. For example, in some embodiments, a method of supporting spectroscopic calibration may include: receiving first calibration data, wherein the first calibration data includes an amount of a chemical element in a first sample and a plurality of spectroscopic intensities, associated with a corresponding plurality of wavelengths, generated by spectroscopic analysis of the first sample by a first spectroscopic instrument; receiving second calibration data, wherein the second calibration data includes an amount of the chemical element in a second sample and a plurality of spectroscopic intensities, associated with a corresponding plurality of wavelengths, generated by spectroscopic analysis of the second sample by a second spectroscopic instrument, and wherein the second spectroscopic instrument is different from the first spectroscopic instrument; and generating a calibration model relating a plurality of spectroscopic intensities at a corresponding plurality of wavelengths to an amount of the chemical element in a sample based on training a machine-learning model using the first calibration data and the second calibration data. In some such embodiments, a number of the plurality of wavelengths, associated with the corresponding plurality of spectroscopic intensities, in the first calibration data is less than a total number of wavelengths with associated spectroscopic intensities output by the first spectroscopic instrument during spectroscopic analysis of the first sample. In some such embodiments, the calibration model is a first calibration model, and the method further includes: receiving third calibration data, wherein the third calibration data includes an amount of the chemical element in a third calibration sample and a plurality of spectroscopic intensities, associated with a corresponding plurality of wavelengths, generated by spectroscopic analysis of the third sample by a third spectroscopic instrument, and wherein the third spectroscopic instrument is different from the first spectroscopic instrument and from the second spectroscopic instrument; and generating a second calibration model relating a plurality of spectroscopic intensities at a corresponding plurality of wavelengths to an amount of the chemical element in a sample by training a machine-learning model, based on the first calibration model, using the third calibration data.

The scientific instrument support embodiments disclosed herein may achieve improved performance relative to conventional approaches. For example, conventional calibration of a spectroscopic instrument typically requires the measurement of tens or hundreds of samples, followed by the fitting of the resulting intensity data to the amount of different chemical elements or other constituents of the sample (e.g., using a linear, quadratic, or cubic function). Interactions between different chemical elements in the intensity spectrum of a sample may result in constructive interference, destructive interference, or other (sometimes non-linear) effects, and thus conventional calibration has required the expertise of a highly trained technician to properly compensate for these effects, adding further complexity and time to the calibration process. Additionally, the conventional calibration process may need to be carried out differently and/or may yield a different result for every instrument, requiring significant time and effort. The embodiments disclosed herein thus provide improvements to scientific instrument technology (e.g., improvements in the computer technology supporting such scientific instruments, among other improvements).

The embodiments disclosed herein may achieve faster, more accurate, and less labor-intensive calibration of spectroscopic instruments relative to conventional approaches. For example, as discussed further below, conventional approaches to calibration typically require multiple days of hands-on effort by a highly trained technician in order to achieve a successful calibration. These approaches suffer from a number of technical problems and limitations, including an inability to pivot use of a spectroscopic instrument from one use case to another use case without another full calibration, resulting in downtime of the instrument.

Various ones of the embodiments disclosed herein may improve upon conventional approaches to achieve the technical advantages of faster, more accurate, and less labor-intensive calibration by utilizing specific data from calibrations of similar spectroscopic instruments. Such technical advantages are not achievable by routine and conventional approaches, and all users of systems including such embodiments may benefit from these advantages (e.g., by assisting the user in the performance of a technical task, such as calibration of a spectroscopic instrument, by means of a guided human-machine interaction process). The technical features of the embodiments disclosed herein are thus decidedly unconventional in the field of spectroscopy, as are the combinations of the features of the embodiments disclosed herein. The computational and user interface features disclosed herein do not only involve the collection and comparison of information, but apply new analytical and technical techniques to change the operation of a spectroscopic instrument by improving the calibration of that instrument (without which the instrument could not perform its most basic functions). The present disclosure thus introduces functionality that neither a conventional computing device, nor a human, could perform.

Accordingly, the embodiments of the present disclosure may serve any of a number of technical purposes, such as controlling a specific technical system or process (e.g., a spectroscopic instrument system and associated analytical process); determining from measurements how to control a machine; reducing the amount of calibration data to be processed; and/or providing a more efficient processing of existing calibration data. In particular, the present disclosure provides technical solutions to technical problems, including but not limited to properly calibrating a spectroscopic instrument to achieve accurate analytical results.

The embodiments disclosed herein thus provide improvements to analytical instrument technology (e.g., improvements in the computer technology supporting analytical instrument, among other improvements).

In the following detailed description, reference is made to the accompanying drawings that form a part hereof wherein like numerals designate like parts throughout, and in which is shown, by way of illustration, embodiments that may be practiced. It is to be understood that other embodiments may be utilized, and structural or logical changes may be made, without departing from the scope of the present disclosure. Therefore, the following detailed description is not to be taken in a limiting sense.

Various operations may be described as multiple discrete actions or operations in turn, in a manner that is most helpful in understanding the subject matter disclosed herein. However, the order of description should not be construed as to imply that these operations are necessarily order dependent. In particular, these operations may not be performed in the order of presentation. Operations described may be performed in a different order from the described embodiment. Various additional operations may be performed, and/or described operations may be omitted in additional embodiments.

For the purposes of the present disclosure, the phrases “A and/or B” and “A or B” mean (A), (B), or (A and B). For the purposes of the present disclosure, the phrases “A, B, and/or C” and “A, B, or C” mean (A), (B), (C), (A and B), (A and C), (B and C), or (A, B, and C). Although some elements may be referred to in the singular (e.g., “a processing device”), any appropriate elements may be represented by multiple instances of that element, and vice versa. For example, a set of operations described as performed by a processing device may be implemented with different ones of the operations performed by different processing devices.

The description uses the phrases “an embodiment,” “various embodiments,” and “some embodiments,” each of which may refer to one or more of the same or different embodiments. Furthermore, the terms “comprising,” “including,” “having,” and the like, as used with respect to embodiments of the present disclosure, are synonymous. When used to describe a range of dimensions, the phrase “between X and Y” represents a range that includes X and Y. As used herein, an “apparatus” may refer to any individual device, collection of devices, part of a device, or collections of parts of devices. The drawings are not necessarily to scale.

As noted above, the embodiments disclosed herein may reduce the time and complexity of calibrating new or otherwise uncalibrated (or miscalibrated) spectroscopic instruments. Various embodiments include the use of a base model and/or model transfer via finetuning. As discussed further herein, the base model may be a machine-learning model that is trained on calibration data of multiple spectroscopic instruments (referred to herein as “base” spectroscopic instruments for ease of illustration). Such a base model has been trained on specific data to read the spectrum of the associated type of instrument and account for instrument-to-instrument variations. Embodiments that include model transfer may finetune the base model using a small amount of data from another instrument to “fit” the base model to that other instrument (referred to herein as a “target” instrument for ease of illustration). A finetuned model may thus be trained to read the spectrum of the target instrument and provide an accurate measurement of the desired values with the target instrument. Such a finetuned model may serve as the instrument calibration model and will be used by users of the spectroscopic instrument to make measurements. The finetuning process may provide one or more benefits to the calibration process. For example, various ones of the embodiments disclosed herein may reduce the amount of data from one instrument needed to calibrate that instrument, with only a relatively small amount of data from the instrument needed to teach the base model the variation between the previous instruments and the target instrument. In another example, various ones of the embodiments disclosed herein may automate the model learning and finetuning process, allowing less skilled operators to successfully calibrate and operate an instrument that conventionally required a highly skilled operator capable of manually making decisions regarding the construction of calibration curves.

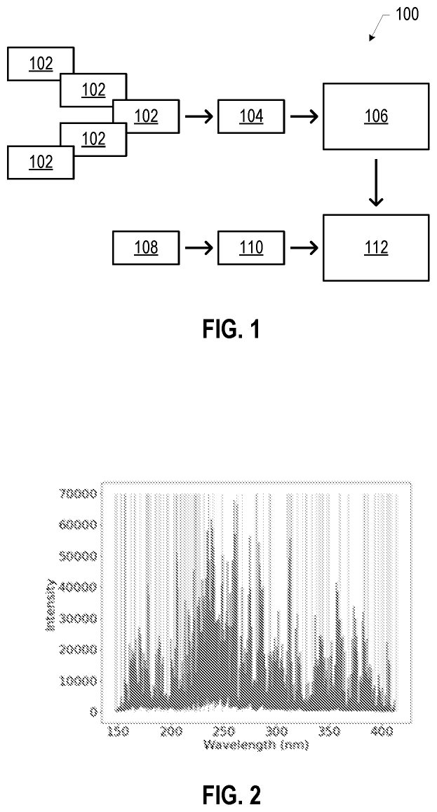

FIG. 1 is a flow diagram of a process 100 for training a base model 106 based on base calibration data 104 from one or more base instruments 102 and finetuning that base model 106 using target calibration data 110 from a target instrument 108 to create a “finetuned” target model 112 that may be used for calibration of the target instrument 108. In particular, the base model 106 and an associated target model 112 may receive, as an input, spectroscopic intensities at multiple wavelengths for a given sample, and may generate, as an output, the amount(s) of one or more chemical elements or other components in the sample. For example, a sample may be provided to a target instrument 108, the resulting output of intensities at one or more wavelengths may be generated, and those intensities/wavelengths may be provided to the target model 112, which may output the amount of various chemical elements in the sample (e.g., 70.27% iron, 18.09% chromium, 9.21% nickel, 0.99% niobium, 0.788% manganese, etc.).

When a target instrument 108 is a new instrument from an existing product line of base instruments 102, a large amount of base calibration data 104 from the calibrating of the base instruments 102 may be available. This base calibration data 104 may reflect complex patterns used to properly understand the spectral data coming from the base instruments 102, and thus this base calibration data 104 may be used to train a base model 106 to read and provide measurements for data collected by the base instruments 102.

One issue with this large set of base calibration data 104 data is that it often includes variations from either intentional or unintentional differences between one or more of the base instruments 102. For example, a particular pixel in the output of one spectroscopic instrument may correspond to a particular wavelength, while that same pixel in the output of another spectroscopic instrument may correspond to a different wavelength. These variations increase the difficulty of learning how to process the spectral data when all the historic calibration data is combined into the base calibration data 104. In some embodiments of the systems and methods disclosed herein, the instrument-to-instrument variation problem may be addressed by distilling the spectral data into simpler features that themselves make up the base calibration data 104, and which features are informed by the physical processes behind the measurements. These distilled spectral features can remove or at least reduce the instrument-to-instrument variability in the base calibration data 104, which may simplify the ML learning process, and thus may (1) reduce the amount of base calibration data 104 required for training the base model 106, (2) reduce the amount of target calibration data 110 required for training the target model 112, and/or (3) result in a more accurate target model 112 for use in calibration.

In some embodiments, the “distilled” features that may be used as the base calibration data 104 to train the base model 106 may correspond to a sampling of the full spectrum available. For example, when the full set of available calibration data includes intensities associated with each of N wavelengths, the base calibration data 104 may include the intensities associated with M wavelengths, where M is less than N. In various embodiments, M may be less than 50% of N, less than 25% of N, less than 10% of N, or less than 5% of N. The particular wavelengths selected for use in the base calibration data 104 may be selected to correspond to those wavelengths at which a line element for a chemical element (or other constituent) of interest appears. As an example, FIG. 2 illustrates, in darker lines, the intensity measurements associated with a particular sample across the full spectrum of available wavelengths, and also illustrates, in lighter lines, the subset of wavelengths used (along with the associated intensities) as part of the base calibration data 104 to train the base model 106. For the example of FIG. 2, the number of wavelengths used in the base calibration data 104 was 120, representing less than 1% of the total available number of wavelengths in the full spectrum.

In some embodiments, the base model 106 and the target model 112 may have the architecture of a deep learning neural network. Such an architecture may allow the base model 106 and the target model 112 to adapt to non-linearities, correlations, anti-correlations, and other relationships in the training calibration data, which may be desirable for calibrating a target instrument 108. Note that the base model 106 and the target model 112 may have the same or similar architectures to facilitate transfer learning between the models.

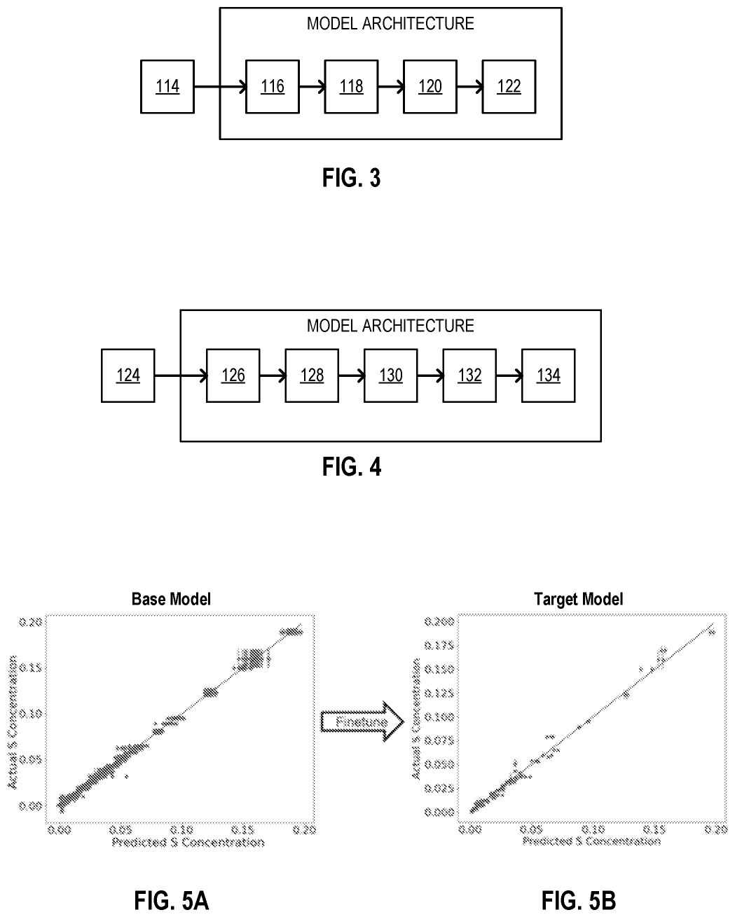

FIG. 3 illustrates an example neural network model architecture for the base model 106/target model 112. The model architecture may include a convolutional layer 116, a first dense layer 118, and a second dense layer 120. The convolutional layer 116 may receive the input 114 (including data representative of spectroscopic intensities at various wavelengths for a sample), the output of the convolutional layer 116 may be provided as input to the first dense layer 118, the output of the first dense layer 118 may be provided as input to the second dense layer 120, and the output of the second dense layer 120 may be provided to the output layer 122 (including data representative of estimated amounts of various chemical elements or other constituents in the sample). In a particular example, the input may be a vector of 52,284 intensity values collected with three different integration methods corresponding to 17,428 wavelengths, the convolutional layer 116 may have two filters with a kernel size of two, the first dense layer 118 may have 28 nodes, the second dense layer 120 may have six nodes, and the output layer 122 may have one node (corresponding to the estimated amount of the associated chemical element or other constituent). The model architecture of FIG. 3 may be a convolutional neural network with fully connected layers, using any suitable activation function (e.g., a rectified linear (ReLU) activation function). The particular number and arrangement of layers in FIG. 3 is simply illustrative, and other numbers and arrangements of layers may be used for the base model 106/target model 112. The use of a convolutional layer like the convolutional layer 116 may be particularly helpful when the input 114 is a substantially full spectrum (rather than a sparsely sampled set of wavelengths, as discussed elsewhere herein). The particular number and arrangement of layers in FIG. 3 is simply illustrative, and other numbers and arrangements of layers may be used for the base model 106/target model 112.

As noted above, in some embodiments, a base model 106 and a target model 112 may be trained to estimate the amounts of multiple chemical elements or other components in a sample based on spectroscopic intensities at multiple wavelengths. In other embodiments, a base model 106 and an associated target model 112 may be trained to estimate the amount of a single chemical element or other component in a sample, and different base models 106/target models 112 may be created to estimate the amounts of different chemical elements in the sample. Thus, in such embodiments, the determination of the amounts of different chemical elements in a sample may involve inputting spectroscopic intensities at multiple wavelengths to different base models 106/target models 112, with each model generating an estimated amount of the associated chemical element in the sample. Creating different models for different chemical elements allows the total amount of computation to be reduced when only a small number of chemical elements are of interest to a particular user, at the cost of managing multiple chemical element-specific models (instead of one multi-chemical element model).

FIG. 4 illustrates an example neural network model architecture for the base model 106/target model 112 in an embodiment in which each chemical element is associated with a different base model 106/target model 112 (and thus identifying the amounts of multiple chemical elements or other constituents in a sample requires the use of multiple associated base models 106/target models 112). In the example of FIG. 4, the first layer 126 may receive the input 124 (including data representative of spectroscopic intensities at various wavelengths for a sample), the output of the first layer 126 may be provided as input to the second layer 128, the output of the second layer 128 may be provided as input to the third layer 130, the output of the third layer 130 may be provided to the fourth layer 132, and the output of the fourth layer 132 may be provided to the output layer 134 (including data representative of an estimated amount of a chemical element or other constituent in the sample). In some embodiments, the input may be a vector of 176 intensity values corresponding to 176 selected wavelengths, the first layer 126 may have 32 nodes, the second layer 128 may have 28 nodes, the third layer 130 may have 6 nodes, the fourth layer 132 may have 3 nodes, and the output layer 134 may have one node (corresponding to the estimated amount of the associated chemical element or other constituent). The model architecture of FIG. 4 may be a fully connected network, using any suitable activation function (e.g., a rectified linear (ReLU) activation function). The particular number and arrangement of layers in FIG. 4 is simply illustrative, and other numbers and arrangements of layers may be used for the base model 106/target model 112.

Any suitable techniques may be used to train the base models 106/target models 112 disclosed herein. For example, mean absolute error may be used as a loss function during training, and training may be stopped early when the error ceases to improve (with some number of epochs, such as 10, providing a “patience” parameter that delays early stopping). In some embodiments, an exponential decay schedule may be used to reduce the learning rate over time.

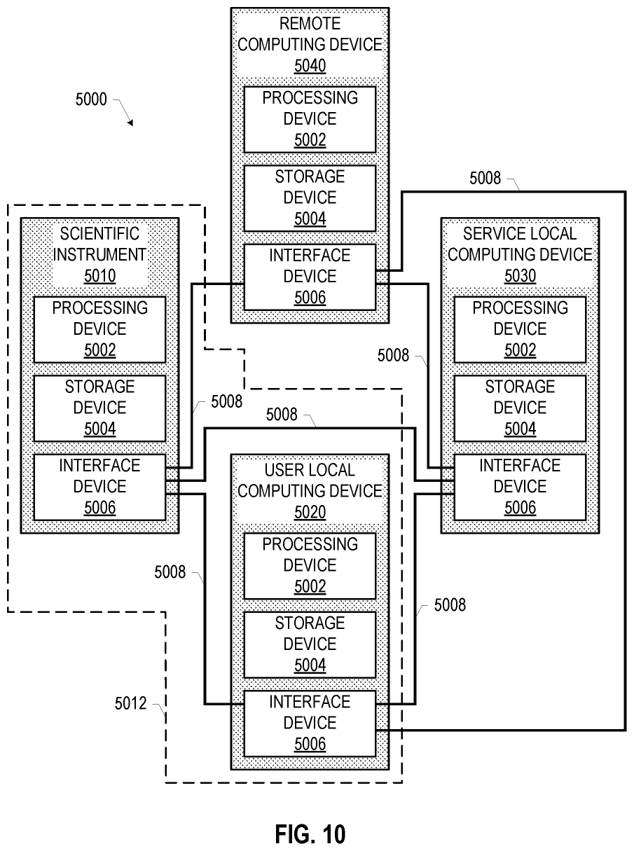

After the base model 106 is trained, it may be stored on a central server (e.g., a remote computing device 5040 and/or a service local computing device 5030, as discussed below with reference to FIG. 10) that can be accessed by operators working on calibrating multiple different spectroscopic instruments. For each target instrument 108 (e.g., a “new” instrument being calibrated), an operator may retrieve the base model 106 and finetune it using the target calibration data 110 to generate a target model 112 for that target instrument 108.

As discussed above, to “transfer” the base model 106 to a target instrument 108, data from the target instrument 108 may be collected and used to finetune the base model 106 to the target instrument 108, resulting in a target model 112. This finetuning process may change the base model 107 to account for differences between the base instruments 102 and the target instrument 108, which is conventionally addressed by creating an entirely new calibration. Unlike in a conventional calibration approach, for the transfer-learning process discussed herein, the operator does not need to understand and identify the particular variances, as the finetuning process will determine those by itself. The deep learning model of the base model 106 and the target model 112 may readily adapt to several types of variations, including spectral shifts, intensity shifts, intensity correlations, non-linear effects, and/or others. Finetuning the base model 106 to generate the target model 112 may be performed in accordance with any suitable techniques known in the art, such as the techniques described in Puneet Mishra, Dário Passos, “Deep calibration transfer: Transferring deep learning models between infrared spectroscopy instruments,” Infrared Physics & Technology, Volume 117, 2021, 103863.

The amount of target calibration data 110 used to finetune a base model 106 may be significantly less than the amount of base calibration data 104 used to train the base model 106, and may also be significantly less than the amount of data needed to carry out a full conventional calibration of the target instrument 108. For example, for some spectroscopic instruments (such as some optical emission spectroscopy (OES) instruments, e.g., spark source spectroscopic instruments), only 10%-20% of the data produced during a conventional calibration may be needed to finetune a base model 106 to achieve a satisfactory target model 112. In some embodiments, once a base model 106 has been finetuned to generate a target model 112, the target calibration data 110 used in the finetuning may be added to the set of base calibration data 104 and used to update the base model 106, as desired.

FIGS. 5A and 5B illustrate example performance results for the use of a base model 106 and a finetuned target model 112, respectively, for calibrating spectroscopic instruments to recognize the amount of sulfur in metal samples, a particularly difficult spectroscopic task. In this particular example, base calibration data 104 from 46 base instruments 102 was used to train the base model 106 to generate a predicted amount of sulfur in a sample based on a measurement of that sample by the base instrument 102, as represented by the strong results in FIG. 5A. The base calibration data 104 used in this example represents data collected over the course of several years of intensive calibration effort. FIG. 5B represents the (also strong) performance of a finetuned target model 112 after the base model 106 was retrained using target calibration data 110 from a target instrument 108, with the amount of target calibration data 110 equal to about 20% of the amount of data conventionally required to calibrate a spectroscopic instrument.

In some embodiments, an initial target model 112 may be generated by the manufacturer or seller of the target instrument 108, and the target model 112 may be re-trained or otherwise updated by the purchaser or other user of the target instrument 108 to achieve a recalibration. Such a recalibration may be performed to compensate for drift or other small variations in performance of the target instrument 108 since the initial calibration, and/or may be performed to enable the target instrument 108 to measure a different use case. For example, a target instrument 108 may be calibrated at the factory with an initial target model 112 for a specific use case, such as to measure iron-based metals in a sample. While the target instrument 108 has all of the components needed for a different use case, such as to measure aluminum-based metals, the target instrument 108 may not have been initially calibrated for that use case; different use cases have typically required different calibrations due to, for example, the different interactions between the elements of the plasma of the spectroscopic instrument. If a user wishes to use the target instrument 108 for a different use case than the one for which it was originally calibrated, conventional calibration requires that the target instrument 108 be sent back to the factory for recalibration, or a technician is sent out to the location of the target instrument 108 to carry out a manual calibration. This results in a lot of downtime and cost to the user, and must be repeated every time the use case changes.

Using the systems and methods disclosed herein, however, the finetuning process can be utilized to allow the user to perform a new calibration of a target instrument 108 rapidly and easily. In some such embodiments, the user would use the target instrument 108 to measure a select number of reference samples (e.g., provided by the manufacturer of the target instrument 108) for the new use case, with the results serving as the target calibration data 110 for use in finetuning a base model 106 trained on base calibration data 104 for the same use case. The resulting target model 112 may serve as a new calibration for the target instrument 108 for the new use case. In some embodiments, the base calibration data 104, the target calibration data 110, and the spectroscopic data provided to the target model 112 during operation of the target instrument 108 may have been pre-processed using conventional methods to, for example, map detector pixels to wavelength, compensate for temperature-induced drift, etc.

The total reduction in calibration complexity and time achieved by the systems and methods disclosed herein relative to conventional approaches may be significant. For example, for conventional calibration of some OES instruments, approximately 100 samples may be needed to calibrate an instrument along with a skilled technician to manually create calibration curves for the instrument. Such a calibration may require 1-2 days to conduct for each individual instrument. Using the systems and methods disclosed herein, the number of samples required to finetune a model for a particular instrument, the amount of input required from a technician, and the technical knowledge of that technician, may all be reduced.

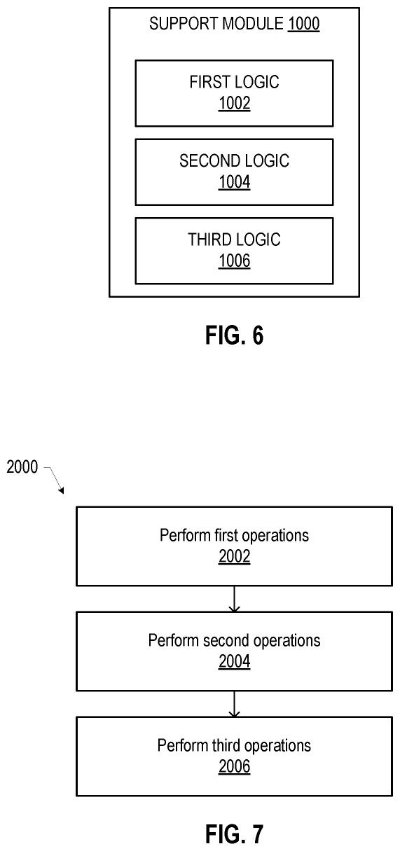

FIG. 6 is a block diagram of a scientific instrument support module 1000 for performing support operations, in accordance with various embodiments. The scientific instrument support module 1000 may be implemented by circuitry (e.g., including electrical and/or optical components), such as a programmed computing device. The logic of the scientific instrument support module 1000 may be included in a single computing device, or may be distributed across multiple computing devices that are in communication with each other as appropriate. Examples of computing devices that may, singly or in combination, implement the scientific instrument support module 1000 are discussed herein with reference to the computing device 4000 of FIG. 9, and examples of systems of interconnected computing devices, in which the scientific instrument support module 1000 may be implemented across one or more of the computing devices, is discussed herein with reference to the scientific instrument support system 5000 of FIG. 10.

The scientific instrument support module 1000 may include first logic 1002, second logic 1004, and third logic 1006. As used herein, the term “logic” may include an apparatus that is to perform a set of operations associated with the logic. For example, any of the logic elements included in the support module 1000 may be implemented by one or more computing devices programmed with instructions to cause one or more processing devices of the computing devices to perform the associated set of operations. In a particular embodiment, a logic element may include one or more non-transitory computer-readable media having instructions thereon that, when executed by one or more processing devices of one or more computing devices, cause the one or more computing devices to perform the associated set of operations. As used herein, the term “module” may refer to a collection of one or more logic elements that, together, perform a function associated with the module. Different ones of the logic elements in a module may take the same form or may take different forms. For example, some logic in a module may be implemented by a programmed general-purpose processing device, while other logic in a module may be implemented by an application-specific integrated circuit (ASIC). In another example, different ones of the logic elements in a module may be associated with different sets of instructions executed by one or more processing devices. A module may not include all of the logic elements depicted in the associated drawing; for example, a module may include a subset of the logic elements depicted in the associated drawing when that module is to perform a subset of the operations discussed herein with reference to that module.

The first logic 1002 may receive calibration data from one or more spectroscopic instruments, in accordance with any of the embodiments disclosed herein. The calibration data may include base calibration data obtained from base spectroscopic instruments, such as the base calibration data 104 of the base spectroscopic instruments 102, and/or target calibration data, such as target calibration data 110 of the target spectroscopic instrument 108.

The second logic 1004 may train and deploy a base machine-learning model trained using the calibration data received by the first logic 1002 (such as a base calibration model 106 trained using base calibration data 104), in accordance with any of the embodiments disclosed herein.

The third logic 1006 may train and deploy a target machine-learning model trained using the calibration data received by the first logic 1002 (such as a target calibration model 112 trained using target calibration data 110), in accordance with any of the embodiments disclosed herein.

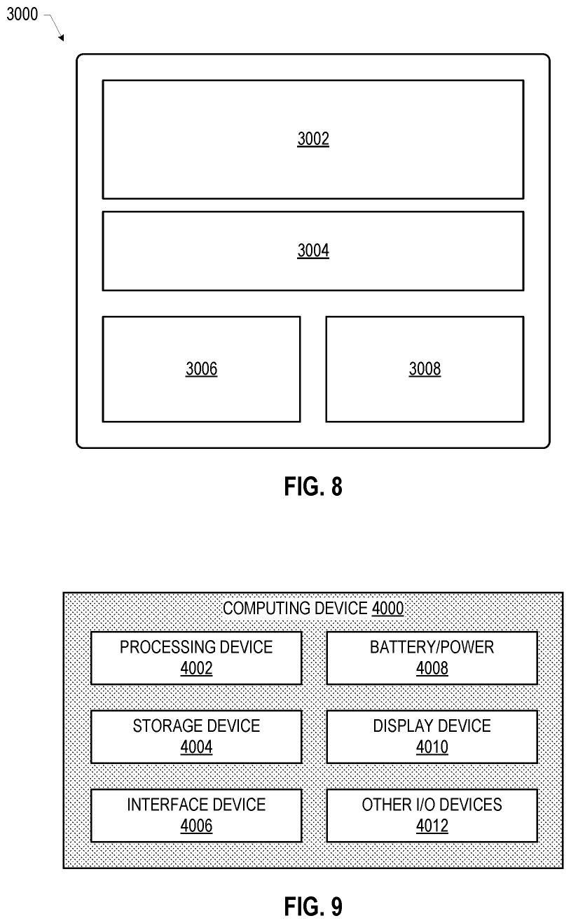

FIG. 7 is a flow diagram of a method 2000 of performing support operations, in accordance with various embodiments. Although the operations of the method 2000 may be illustrated with reference to particular embodiments disclosed herein (e.g., the scientific instrument support modules 1000 discussed herein with reference to FIG. 6, the GUI 3000 discussed herein with reference to FIG. 8, the computing devices 4000 discussed herein with reference to FIG. 9, and/or the scientific instrument support system 5000 discussed herein with reference to FIG. 10), the method 2000 may be used in any suitable setting to perform any suitable support operations. Operations are illustrated once each and in a particular order in FIG. 7, but the operations may be reordered and/or repeated as desired and appropriate (e.g., different operations performed may be performed in parallel, as suitable).

At 2002, first operations may be performed. For example, the first logic 1002 of a support module 1000 may perform the operations of 2002. The first operations may include receiving calibration data from one or more spectroscopic instruments, in accordance with any of the embodiments disclosed herein. The calibration data may include base calibration data obtained from base spectroscopic instruments, such as the base calibration data 104 of the base spectroscopic instruments 102, and/or target calibration data, such as target calibration data 110 of the target spectroscopic instrument 108.

At 2004, second operations may be performed. For example, the second logic 1004 of a support module 1000 may perform the operations of 2004. The second operations may include training and deploying a base machine-learning model trained using the calibration data received at 2002 (such as a base calibration model 106 trained using base calibration data 104), in accordance with any of the embodiments disclosed herein.

At 2006, third operations may be performed. For example, the third logic 1006 of a support module 1000 may perform the operations of 2006. The third operations may include training and deploying a target machine-learning model trained using the calibration data received at 2002 (such as a target calibration model 112 trained using target calibration data 110), in accordance with any of the embodiments disclosed herein.

The scientific instrument support methods disclosed herein may include interactions with a human user (e.g., via the user local computing device 5020 discussed herein with reference to FIG. 10). These interactions may include providing information to the user (e.g., information regarding the operation of a scientific instrument such as the scientific instrument 5010 of FIG. 10, information regarding a sample being analyzed or other test or measurement performed by a scientific instrument, information retrieved from a local or remote database, or other information) or providing an option for a user to input commands (e.g., to control the operation of a scientific instrument such as the scientific instrument 5010 of FIG. 10, or to control the analysis of data generated by a scientific instrument), queries (e.g., to a local or remote database), or other information. In some embodiments, these interactions may be performed through a graphical user interface (GUI) that includes a visual display on a display device (e.g., the display device 4010 discussed herein with reference to FIG. 9) that provides outputs to the user and/or prompts the user to provide inputs (e.g., via one or more input devices, such as a keyboard, mouse, trackpad, or touchscreen, included in the other I/O devices 4012 discussed herein with reference to FIG. 9). The scientific instrument support systems disclosed herein may include any suitable GUIs for interaction with a user.

FIG. 8 depicts an example GUI 3000 that may be used in the performance of some or all of the support methods disclosed herein, in accordance with various embodiments. As noted above, the GUI 3000 may be provided on a display device (e.g., the display device 4010 discussed herein with reference to FIG. 9) of a computing device (e.g., the computing device 4000 discussed herein with reference to FIG. 9) of a scientific instrument support system (e.g., the scientific instrument support system 5000 discussed herein with reference to FIG. 10), and a user may interact with the GUI 3000 using any suitable input device (e.g., any of the input devices included in the other I/O devices 4012 discussed herein with reference to FIG. 9) and input technique (e.g., movement of a cursor, motion capture, facial recognition, gesture detection, voice recognition, actuation of buttons, etc.).

The GUI 3000 may include a data display region 3002, a data analysis region 3004, a scientific instrument control region 3006, and a settings region 3008. The particular number and arrangement of regions depicted in FIG. 8 is simply illustrative, and any number and arrangement of regions, including any desired features, may be included in a GUI 3000.

The data display region 3002 may display data generated by a scientific instrument (e.g., the scientific instrument 5010 discussed herein with reference to FIG. 10). For example, the data display region 3002 may display the intensities associated with different wavelengths, as known in the art.

The data analysis region 3004 may display the results of data analysis (e.g., the results of analyzing the data illustrated in the data display region 3002 and/or other data). For example, the data analysis region 3004 may display the amount of a chemical element or other constituent in a sample, generated based on the intensities associated with different wavelengths and a calibration model, as discussed herein. In some embodiments, the data display region 3002 and the data analysis region 3004 may be combined in the GUI 3000 (e.g., to include data output from a scientific instrument, and some analysis of the data, in a common graph or region).

The scientific instrument control region 3006 may include options that allow the user to control a scientific instrument (e.g., the scientific instrument 5010 discussed herein with reference to FIG. 10). For example, the scientific instrument control region 3006 may include options to initiate a calibration (which may result in prompts to a user regarding how to perform the calibration).

The settings region 3008 may include options that allow the user to control the features and functions of the GUI 3000 (and/or other GUIs) and/or perform common computing operations with respect to the data display region 3002 and data analysis region 3004 (e.g., saving data on a storage device, such as the storage device 4004 discussed herein with reference to FIG. 9, sending data to another user, labeling data, etc.). For example, the settings region 3008 may include options to change the use case (which may trigger a re-calibration, as discussed herein).

As noted above, the scientific instrument support module 1000 may be implemented by one or more computing devices. FIG. 9 is a block diagram of a computing device 4000 that may perform some or all of the scientific instrument support methods disclosed herein, in accordance with various embodiments. In some embodiments, the scientific instrument support module 1000 may be implemented by a single computing device 4000 or by multiple computing devices 4000. Further, as discussed below, a computing device 4000 (or multiple computing devices 4000) that implements the scientific instrument support module 1000 may be part of one or more of the scientific instrument 5010, the user local computing device 5020, the service local computing device 5030, or the remote computing device 5040 of FIG. 10.

The computing device 4000 of FIG. 9 is illustrated as having a number of components, but any one or more of these components may be omitted or duplicated, as suitable for the application and setting. In some embodiments, some or all of the components included in the computing device 4000 may be attached to one or more motherboards and enclosed in a housing (e.g., including plastic, metal, and/or other materials). In some embodiments, some these components may be fabricated onto a single system-on-a-chip (SoC) (e.g., an SoC may include one or more processing devices 4002 and one or more storage devices 4004). Additionally, in various embodiments, the computing device 4000 may not include one or more of the components illustrated in FIG. 9, but may include interface circuitry (not shown) for coupling to the one or more components using any suitable interface (e.g., a Universal Serial Bus (USB) interface, a High-Definition Multimedia Interface (HDMI) interface, a Controller Area Network (CAN) interface, a Serial Peripheral Interface (SPI) interface, an Ethernet interface, a wireless interface, or any other appropriate interface). For example, the computing device 4000 may not include a display device 4010, but may include display device interface circuitry (e.g., a connector and driver circuitry) to which a display device 4010 may be coupled.

The computing device 4000 may include a processing device 4002 (e.g., one or more processing devices). As used herein, the term “processing device” may refer to any device or portion of a device that processes electronic data from registers and/or memory to transform that electronic data into other electronic data that may be stored in registers and/or memory. The processing device 4002 may include one or more digital signal processors (DSPs), application-specific integrated circuits (ASICs), central processing units (CPUs), graphics processing units (GPUs), cryptoprocessors (specialized processors that execute cryptographic algorithms within hardware), server processors, or any other suitable processing devices.

The computing device 4000 may include a storage device 4004 (e.g., one or more storage devices). The storage device 4004 may include one or more memory devices such as random access memory (RAM) (e.g., static RAM (SRAM) devices, magnetic RAM (MRAM) devices, dynamic RAM (DRAM) devices, resistive RAM (RRAM) devices, or conductive-bridging RAM (CBRAM) devices), hard drive-based memory devices, solid-state memory devices, networked drives, cloud drives, or any combination of memory devices. In some embodiments, the storage device 4004 may include memory that shares a die with a processing device 4002. In such an embodiment, the memory may be used as cache memory and may include embedded dynamic random access memory (eDRAM) or spin transfer torque magnetic random access memory (STT-MRAM), for example. In some embodiments, the storage device 4004 may include non-transitory computer readable media having instructions thereon that, when executed by one or more processing devices (e.g., the processing device 4002), cause the computing device 4000 to perform any appropriate ones of or portions of the methods disclosed herein.

The computing device 4000 may include an interface device 4006 (e.g., one or more interface devices 4006). The interface device 4006 may include one or more communication chips, connectors, and/or other hardware and software to govern communications between the computing device 4000 and other computing devices. For example, the interface device 4006 may include circuitry for managing wireless communications for the transfer of data to and from the computing device 4000. The term “wireless” and its derivatives may be used to describe circuits, devices, systems, methods, techniques, communications channels, etc., that may communicate data through the use of modulated electromagnetic radiation through a nonsolid medium. The term does not imply that the associated devices do not contain any wires, although in some embodiments they might not. Circuitry included in the interface device 4006 for managing wireless communications may implement any of a number of wireless standards or protocols, including but not limited to Institute for Electrical and Electronic Engineers (IEEE) standards including Wi-Fi (IEEE 802.11 family), IEEE 802.16 standards (e.g., IEEE 802.16-2005 Amendment), Long-Term Evolution (LTE) project along with any amendments, updates, and/or revisions (e.g., advanced LTE project, ultra mobile broadband (UMB) project (also referred to as “3GPP2”), etc.). In some embodiments, circuitry included in the interface device 4006 for managing wireless communications may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. In some embodiments, circuitry included in the interface device 4006 for managing wireless communications may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). In some embodiments, circuitry included in the interface device 4006 for managing wireless communications may operate in accordance with Code Division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. In some embodiments, the interface device 4006 may include one or more antennas (e.g., one or more antenna arrays) to receipt and/or transmission of wireless communications.

In some embodiments, the interface device 4006 may include circuitry for managing wired communications, such as electrical, optical, or any other suitable communication protocols. For example, the interface device 4006 may include circuitry to support communications in accordance with Ethernet technologies. In some embodiments, the interface device 4006 may support both wireless and wired communication, and/or may support multiple wired communication protocols and/or multiple wireless communication protocols. For example, a first set of circuitry of the interface device 4006 may be dedicated to shorter-range wireless communications such as Wi-Fi or Bluetooth, and a second set of circuitry of the interface device 4006 may be dedicated to longer-range wireless communications such as global positioning system (GPS), EDGE, GPRS, CDMA, WiMAX, LTE, EV-DO, or others. In some embodiments, a first set of circuitry of the interface device 4006 may be dedicated to wireless communications, and a second set of circuitry of the interface device 4006 may be dedicated to wired communications.

The computing device 4000 may include battery/power circuitry 4008. The battery/power circuitry 4008 may include one or more energy storage devices (e.g., batteries or capacitors) and/or circuitry for coupling components of the computing device 4000 to an energy source separate from the computing device 4000 (e.g., AC line power).

The computing device 4000 may include a display device 4010 (e.g., multiple display devices). The display device 4010 may include any visual indicators, such as a heads-up display, a computer monitor, a projector, a touchscreen display, a liquid crystal display (LCD), a light-emitting diode display, or a flat panel display.

The computing device 4000 may include other input/output (I/O) devices 4012. The other I/O devices 4012 may include one or more audio output devices (e.g., speakers, headsets, earbuds, alarms, etc.), one or more audio input devices (e.g., microphones or microphone arrays), location devices (e.g., GPS devices in communication with a satellite-based system to receive a location of the computing device 4000, as known in the art), audio codecs, video codecs, printers, sensors (e.g., thermocouples or other temperature sensors, humidity sensors, pressure sensors, vibration sensors, accelerometers, gyroscopes, etc.), image capture devices such as cameras, keyboards, cursor control devices such as a mouse, a stylus, a trackball, or a touchpad, bar code readers, Quick Response (QR) code readers, or radio frequency identification (RFID) readers, for example.

The computing device 4000 may have any suitable form factor for its application and setting, such as a handheld or mobile computing device (e.g., a cell phone, a smart phone, a mobile internet device, a tablet computer, a laptop computer, a netbook computer, an ultrabook computer, a personal digital assistant (PDA), an ultra mobile personal computer, etc.), a desktop computing device, or a server computing device or other networked computing component.

One or more computing devices implementing any of the scientific instrument support modules or methods disclosed herein may be part of a scientific instrument support system. FIG. 10 is a block diagram of an example scientific instrument support system 5000 in which some or all of the scientific instrument support methods disclosed herein may be performed, in accordance with various embodiments. The scientific instrument support modules and methods disclosed herein (e.g., the scientific instrument support module 1000 of FIG. 6 and the method 2000 of FIG. 7) may be implemented by one or more of the scientific instrument 5010, the user local computing device 5020, the service local computing device 5030, or the remote computing device 5040 of the scientific instrument support system 5000.

Any of the scientific instrument 5010, the user local computing device 5020, the service local computing device 5030, or the remote computing device 5040 may include any of the embodiments of the computing device 4000 discussed herein with reference to FIG. 9, and any of the scientific instrument 5010, the user local computing device 5020, the service local computing device 5030, or the remote computing device 5040 may take the form of any appropriate ones of the embodiments of the computing device 4000 discussed herein with reference to FIG. 9.

The scientific instrument 5010, the user local computing device 5020, the service local computing device 5030, or the remote computing device 5040 may each include a processing device 5002, a storage device 5004, and an interface device 5006. The processing device 5002 may take any suitable form, including the form of any of the processing devices 4002 discussed herein with reference to FIG. 9, and the processing devices 5002 included in different ones of the scientific instrument 5010, the user local computing device 5020, the service local computing device 5030, or the remote computing device 5040 may take the same form or different forms. The storage device 5004 may take any suitable form, including the form of any of the storage devices 5004 discussed herein with reference to FIG. 9, and the storage devices 5004 included in different ones of the scientific instrument 5010, the user local computing device 5020, the service local computing device 5030, or the remote computing device 5040 may take the same form or different forms. The interface device 5006 may take any suitable form, including the form of any of the interface devices 4006 discussed herein with reference to FIG. 9, and the interface devices 5006 included in different ones of the scientific instrument 5010, the user local computing device 5020, the service local computing device 5030, or the remote computing device 5040 may take the same form or different forms.

The scientific instrument 5010, the user local computing device 5020, the service local computing device 5030, and the remote computing device 5040 may be in communication with other elements of the scientific instrument support system 5000 via communication pathways 5008. The communication pathways 5008 may communicatively couple the interface devices 5006 of different ones of the elements of the scientific instrument support system 5000, as shown, and may be wired or wireless communication pathways (e.g., in accordance with any of the communication techniques discussed herein with reference to the interface devices 4006 of the computing device 4000 of FIG. 9). The particular scientific instrument support system 5000 depicted in FIG. 10 includes communication pathways between each pair of the scientific instrument 5010, the user local computing device 5020, the service local computing device 5030, and the remote computing device 5040, but this “fully connected” implementation is simply illustrative, and in various embodiments, various ones of the communication pathways 5008 may be absent. For example, in some embodiments, a service local computing device 5030 may not have a direct communication pathway 5008 between its interface device 5006 and the interface device 5006 of the scientific instrument 5010, but may instead communicate with the scientific instrument 5010 via the communication pathway 5008 between the service local computing device 5030 and the user local computing device 5020 and the communication pathway 5008 between the user local computing device 5020 and the scientific instrument 5010.

The scientific instrument 5010 may include any appropriate scientific instrument, such as a spectroscopic instrument (e.g., an OES instrument).

The user local computing device 5020 may be a computing device (e.g., in accordance with any of the embodiments of the computing device 4000 discussed herein) that is local to a user of the scientific instrument 5010. In some embodiments, the user local computing device 5020 may also be local to the scientific instrument 5010, but this need not be the case; for example, a user local computing device 5020 that is in a user's home or office may be remote from, but in communication with, the scientific instrument 5010 so that the user may use the user local computing device 5020 to control and/or access data from the scientific instrument 5010. In some embodiments, the user local computing device 5020 may be a laptop, smartphone, or tablet device. In some embodiments the user local computing device 5020 may be a portable computing device.

The service local computing device 5030 may be a computing device (e.g., in accordance with any of the embodiments of the computing device 4000 discussed herein) that is local to an entity that services the scientific instrument 5010. For example, the service local computing device 5030 may be local to a manufacturer of the scientific instrument 5010 or to a third-party service company. In some embodiments, the service local computing device 5030 may communicate with the scientific instrument 5010, the user local computing device 5020, and/or the remote computing device 5040 (e.g., via a direct communication pathway 5008 or via multiple “indirect” communication pathways 5008, as discussed above) to receive data regarding the operation of the scientific instrument 5010, the user local computing device 5020, and/or the remote computing device 5040 (e.g., the results of self-tests of the scientific instrument 5010, calibration coefficients used by the scientific instrument 5010, the measurements of sensors associated with the scientific instrument 5010, etc.). In some embodiments, the service local computing device 5030 may communicate with the scientific instrument 5010, the user local computing device 5020, and/or the remote computing device 5040 (e.g., via a direct communication pathway 5008 or via multiple “indirect” communication pathways 5008, as discussed above) to transmit data to the scientific instrument 5010, the user local computing device 5020, and/or the remote computing device 5040 (e.g., to update programmed instructions, such as firmware, in the scientific instrument 5010, to initiate the performance of test or calibration sequences in the scientific instrument 5010, to update programmed instructions, such as software, in the user local computing device 5020 or the remote computing device 5040, etc.). A user of the scientific instrument 5010 may utilize the scientific instrument 5010 or the user local computing device 5020 to communicate with the service local computing device 5030 to report a problem with the scientific instrument 5010 or the user local computing device 5020, to request a visit from a technician to improve the operation of the scientific instrument 5010, to order consumables or replacement parts associated with the scientific instrument 5010, or for other purposes.

The remote computing device 5040 may be a computing device (e.g., in accordance with any of the embodiments of the computing device 4000 discussed herein) that is remote from the scientific instrument 5010 and/or from the user local computing device 5020. In some embodiments, the remote computing device 5040 may be included in a datacenter or other large-scale server environment. In some embodiments, the remote computing device 5040 may include network-attached storage (e.g., as part of the storage device 5004). The remote computing device 5040 may store data generated by the scientific instrument 5010, perform analyses of the data generated by the scientific instrument 5010 (e.g., in accordance with programmed instructions), facilitate communication between the user local computing device 5020 and the scientific instrument 5010, and/or facilitate communication between the service local computing device 5030 and the scientific instrument 5010.

In some embodiments, one or more of the elements of the scientific instrument support system 5000 illustrated in FIG. 10 may not be present. Further, in some embodiments, multiple ones of various ones of the elements of the scientific instrument support system 5000 of FIG. 10 may be present. For example, a scientific instrument support system 5000 may include multiple user local computing devices 5020 (e.g., different user local computing devices 5020 associated with different users or in different locations). In another example, a scientific instrument support system 5000 may include multiple scientific instruments 5010, all in communication with service local computing device 5030 and/or a remote computing device 5040; in such an embodiment, the service local computing device 5030 may monitor these multiple scientific instruments 5010, and the service local computing device 5030 may cause updates or other information may be “broadcast” to multiple scientific instruments 5010 at the same time. Different ones of the scientific instruments 5010 in a scientific instrument support system 5000 may be located close to one another (e.g., in the same room) or farther from one another (e.g., on different floors of a building, in different buildings, in different cities, etc.). In some embodiments, a scientific instrument 5010 may be connected to an Internet-of-Things (IoT) stack that allows for command and control of the scientific instrument 5010 through a web-based application, a virtual or augmented reality application, a mobile application, and/or a desktop application. Any of these applications may be accessed by a user operating the user local computing device 5020 in communication with the scientific instrument 5010 by the intervening remote computing device 5040. In some embodiments, a scientific instrument 5010 may be sold by the manufacturer along with one or more associated user local computing devices 5020 as part of a local scientific instrument computing unit 5012.

The following paragraphs include examples of various ones of the embodiments disclosed herein.

Example 1 is a method of supporting spectroscopic calibration, including: receiving first calibration data, wherein the first calibration data includes an amount of a chemical element in a first sample and a plurality of spectroscopic intensities, associated with a corresponding plurality of wavelengths, generated by spectroscopic analysis of the first sample by a first spectroscopic instrument; receiving second calibration data, wherein the second calibration data includes an amount of the chemical element in a second sample and a plurality of spectroscopic intensities, associated with a corresponding plurality of wavelengths, generated by spectroscopic analysis of the second sample by a second spectroscopic instrument, and wherein the second spectroscopic instrument is different from the first spectroscopic instrument; generating a calibration model relating a plurality of spectroscopic intensities at a corresponding plurality of wavelengths to an amount of the chemical element in a sample based on training a machine-learning model using the first calibration data and the second calibration data; receiving third calibration data, wherein the third calibration data includes an amount of the chemical element in a third calibration sample and a plurality of spectroscopic intensities, associated with a corresponding plurality of wavelengths, generated by spectroscopic analysis of the third sample by a third spectroscopic instrument, and wherein the third spectroscopic instrument is different from the first spectroscopic instrument and from the second spectroscopic instrument; and generating a second calibration model relating a plurality of spectroscopic intensities at a corresponding plurality of wavelengths to an amount of the chemical element in a sample by training a machine-learning model, based on the first calibration model, using the third calibration data.

Example 2 includes the subject matter of Example 1, and further specifies that the first sample has a same material composition as the second sample.

Example 3 includes the subject matter of Example 1, and further specifies that the first sample has a different material composition than the second sample.

Example 4 includes the subject matter of any of Examples 1-3, and further specifies that a number of the plurality of wavelengths, associated with the corresponding plurality of spectroscopic intensities, in the first calibration data is less than a total number of wavelengths with associated spectroscopic intensities output by the first spectroscopic instrument during spectroscopic analysis of the first sample.

Example 5 includes the subject matter of any of Examples 1-4, and further specifies that a number of the plurality of wavelengths, associated with the corresponding plurality of spectroscopic intensities, in the second calibration data is less than a total number of wavelengths with associated spectroscopic intensities output by the second spectroscopic instrument during spectroscopic analysis of the second sample.

Example 6 includes the subject matter of any of Examples 1-5, and further includes: using the calibration model to output an amount of the chemical element in a sample-under-test based on a plurality of spectroscopic intensities, associated with a corresponding plurality of wavelengths, generated by spectroscopic analysis of the sample-under-test.

Example 7 includes the subject matter of any of Examples 1-6, and further specifies that the third sample has a same material composition as the second sample.

Example 8 includes the subject matter of any of Examples 1-6, and further specifies that the third sample has a different material composition than the second sample.

Example 9 includes the subject matter of any of Examples 1-8, and further specifies that a number of the plurality of wavelengths, associated with the corresponding plurality of spectroscopic intensities, in the third calibration data is less than a total number of wavelengths with associated spectroscopic intensities output by the third spectroscopic instrument during spectroscopic analysis of the third sample.

Example 10 includes the subject matter of any of Examples 1-9, and further includes: using the second calibration model to output an amount of the chemical element in a sample-under-test based on a plurality of spectroscopic intensities, associated with a corresponding plurality of wavelengths, generated by spectroscopic analysis of the sample-under-test by the third spectroscopic instrument.

Example 11 includes the subject matter of any of Examples 1-10, and further specifies that an amount of the third calibration data used to generate the second calibration model is less than an amount of the first calibration data used to generate the first calibration model.

Example 12 is a method of supporting spectroscopic calibration, including: receiving calibration data, wherein the calibration data includes an amount of a chemical element in a sample and a plurality of spectroscopic intensities, associated with a corresponding plurality of wavelengths, generated by spectroscopic analysis of the sample by a spectroscopic instrument, and wherein a number of the plurality of wavelengths, associated with the corresponding plurality of spectroscopic intensities, in the calibration data is less than a total number of wavelengths with associated spectroscopic intensities output by the spectroscopic instrument during spectroscopic analysis of the sample; and generating a calibration model relating a plurality of spectroscopic intensities at a corresponding plurality of wavelengths to an amount of the chemical element in a sample based on training a machine-learning model using the calibration data; and receiving second calibration data, wherein the second calibration data includes an amount of the chemical element in a second sample and a plurality of spectroscopic intensities, associated with a corresponding plurality of wavelengths, generated by spectroscopic analysis of the second sample by a second spectroscopic instrument, wherein a number of the plurality of wavelengths, associated with the corresponding plurality of spectroscopic intensities, in the second calibration data is less than a total number of wavelengths with associated spectroscopic intensities output by the second spectroscopic instrument during spectroscopic analysis of the sample, and wherein the second spectroscopic instrument is different from the first spectroscopic instrument; wherein the calibration model is generated based on training the machine-learning model using the second calibration data.

Example 13 includes the subject matter of Example 12, and further specifies that the first sample has a same material composition as the second sample.

Example 14 includes the subject matter of Example 12, and further specifies that the first sample has a different material composition than the second sample.

Example 15 includes the subject matter of any of Examples 12-14, and further includes: using the calibration model to output an amount of the chemical element in a sample-under-test based on a plurality of spectroscopic intensities, associated with a corresponding plurality of wavelengths, generated by spectroscopic analysis of the sample-under-test.

Example 16 includes the subject matter of any of Examples 12-15, and further specifies that the calibration model is a first calibration model, the spectroscopic instrument is a first spectroscopic instrument, the calibration data is first calibration data, and the method further includes: receiving second calibration data, wherein the second calibration data includes an amount of the chemical element in a second calibration sample and a plurality of spectroscopic intensities, associated with a corresponding plurality of wavelengths, generated by spectroscopic analysis of the second sample by a second spectroscopic instrument, and wherein the second spectroscopic instrument is different from the first spectroscopic instrument; and generating a second calibration model relating a plurality of spectroscopic intensities at a corresponding plurality of wavelengths to an amount of the chemical element in a sample by training a machine-learning model, based on the first calibration model, using the second calibration data.

Example 17 includes the subject matter of Example 16, and further specifies that the second sample has a same material composition as the first sample.

Example 18 includes the subject matter of Example 16, and further specifies that the second sample has a different material composition than the first sample.

Example 19 includes the subject matter of any of Examples 16-18, and further specifies that a number of the plurality of wavelengths, associated with the corresponding plurality of spectroscopic intensities, in the second calibration data is less than a total number of wavelengths with associated spectroscopic intensities output by the second spectroscopic instrument during spectroscopic analysis of the second sample.

Example 20 includes the subject matter of any of Examples 16-19, and further includes: using the second calibration model to output an amount of the chemical element in a sample-under-test based on a plurality of spectroscopic intensities, associated with a corresponding plurality of wavelengths, generated by spectroscopic analysis of the sample-under-test by the second spectroscopic instrument.

Example 21 includes the subject matter of any of Examples 16-20, and further specifies that an amount of the second calibration data used to generate the second calibration model is less than an amount of the first calibration data used to generate the first calibration model.

Example 22 is a method of supporting spectroscopic calibration, including: receiving calibration data, wherein the calibration data includes an amount of a chemical element in a sample and a plurality of spectroscopic intensities, associated with a corresponding plurality of wavelengths, generated by spectroscopic analysis of the sample by a spectroscopic instrument, and wherein a number of the plurality of wavelengths, associated with the corresponding plurality of spectroscopic intensities, in the calibration data is less than a total number of wavelengths with associated spectroscopic intensities output by the spectroscopic instrument during spectroscopic analysis of the sample; and generating a target calibration model for the spectroscopic instrument relating a plurality of spectroscopic intensities at a corresponding plurality of wavelengths to an amount of a chemical element in a sample based on training a machine-learning model, based on a base machine-learning model, using the calibration data for the spectroscopic instrument, wherein the base machine-learning model is trained on calibration data from one or more spectroscopic instruments different from the spectroscopic instrument.

Example 23 includes the subject matter of Example 22, and further includes: using the target calibration model to output an amount of the chemical element in a sample-under-test based on a plurality of spectroscopic intensities, associated with a corresponding plurality of wavelengths, generated by spectroscopic analysis by the spectroscopic instrument of the sample-under-test.

Example 24 is a method of supporting spectroscopic calibration, including: receiving calibration data, wherein the calibration data includes an amount of a chemical element in a sample and a plurality of spectroscopic intensities, associated with a corresponding plurality of wavelengths, generated by spectroscopic analysis of the sample by a spectroscopic instrument; and generating a target calibration model for the spectroscopic instrument relating a plurality of spectroscopic intensities at a corresponding plurality of wavelengths to an amount of a chemical element in a sample based on training a machine-learning model, based on a base machine-learning model, using the calibration data for the spectroscopic instrument, wherein the base machine-learning model is trained on calibration data from a plurality of spectroscopic instruments different from the spectroscopic instrument.

Example 25 includes the subject matter of Example 24, and further specifies that a number of the plurality of wavelengths, associated with the corresponding plurality of spectroscopic intensities, in the calibration data is less than a total number of wavelengths with associated spectroscopic intensities output by the spectroscopic instrument during spectroscopic analysis of the sample.

Example 26 includes the subject matter of any of Examples 24-25, and further includes: using the target calibration model to output an amount of the chemical element in a sample-under-test based on a plurality of spectroscopic intensities, associated with a corresponding plurality of wavelengths, generated by spectroscopic analysis by the spectroscopic instrument of the sample-under-test.

Example 27 is a computer-implemented method comprising any of the methods disclosed herein (e.g., any of the methods of Examples 1-26)

Example 28 is a method carried out by a computer comprising any of the methods disclosed herein (e.g., any of the methods of Examples 1-26).

Example 29 is a data processing apparatus, device, or system comprising means for carrying out any of the methods disclosed herein (e.g., any of the methods of Examples 1-26).

Example 30 is a data processing apparatus, device, or system comprising a processor adapted to or configured to perform any of the methods disclosed herein (e.g., any of the methods of Examples 1-26).

Example 31 is a computer-readable medium comprising instructions which, when executed by a computer, cause the computer to carry out any of the methods disclosed herein (e.g., any of the methods of Examples 1-26).

Example 32 is a computer program product comprising instructions which, when the program is executed by a computer, cause the computer to carry out any of the methods disclosed herein (e.g., any of the methods of Examples 1-26).

Example 33 includes any of the scientific instrument support modules disclosed herein.

Example 34 includes any of the methods disclosed herein.

Example 35 includes any of the GUIs disclosed herein.

Example 36 includes any of the scientific instrument support computing devices and systems disclosed herein.

1. A method of supporting spectroscopic calibration, comprising:
receiving first calibration data, wherein the first calibration data includes an amount of a chemical element in a first sample and a plurality of spectroscopic intensities, associated with a corresponding plurality of wavelengths, generated by spectroscopic analysis of the first sample by a first spectroscopic instrument;
receiving second calibration data, wherein the second calibration data includes an amount of the chemical element in a second sample and a plurality of spectroscopic intensities, associated with a corresponding plurality of wavelengths, generated by spectroscopic analysis of the second sample by a second spectroscopic instrument, and wherein the second spectroscopic instrument is different from the first spectroscopic instrument;
generating a calibration model relating a plurality of spectroscopic intensities at a corresponding plurality of wavelengths to an amount of the chemical element in a sample based on training a machine-learning model using the first calibration data and the second calibration data;
receiving third calibration data, wherein the third calibration data includes an amount of the chemical element in a third calibration sample and a plurality of spectroscopic intensities, associated with a corresponding plurality of wavelengths, generated by spectroscopic analysis of the third sample by a third spectroscopic instrument, and wherein the third spectroscopic instrument is different from the first spectroscopic instrument and from the second spectroscopic instrument; and
generating a second calibration model relating a plurality of spectroscopic intensities at a corresponding plurality of wavelengths to an amount of the chemical element in a sample by training a machine-learning model, based on the first calibration model, using the third calibration data.

2. The method of claim 1, wherein a number of the plurality of wavelengths, associated with the corresponding plurality of spectroscopic intensities, in the first calibration data is less than a total number of wavelengths with associated spectroscopic intensities output by the first spectroscopic instrument during spectroscopic analysis of the first sample.

3. The method of claim 1, wherein a number of the plurality of wavelengths, associated with the corresponding plurality of spectroscopic intensities, in the second calibration data is less than a total number of wavelengths with associated spectroscopic intensities output by the second spectroscopic instrument during spectroscopic analysis of the second sample.

4. The method of claim 1, further comprising:
using the calibration model to output an amount of the chemical element in a sample-under-test based on a plurality of spectroscopic intensities, associated with a corresponding plurality of wavelengths, generated by spectroscopic analysis of the sample-under-test.

5. The method of claim 1, wherein the third sample has a same material composition as the second sample.

6. The method of claim 1, wherein the third sample has a different material composition than the second sample.

7. The method of claim 1, wherein a number of the plurality of wavelengths, associated with the corresponding plurality of spectroscopic intensities, in the third calibration data is less than a total number of wavelengths with associated spectroscopic intensities output by the third spectroscopic instrument during spectroscopic analysis of the third sample.

8. The method of claim 1, further comprising:
using the second calibration model to output an amount of the chemical element in a sample-under-test based on a plurality of spectroscopic intensities, associated with a corresponding plurality of wavelengths, generated by spectroscopic analysis of the sample-under-test by the third spectroscopic instrument.

9. The method of claim 1, wherein an amount of the third calibration data used to generate the second calibration model is less than an amount of the first calibration data used to generate the first calibration model.

10. A method of supporting spectroscopic calibration, comprising:
receiving calibration data, wherein the calibration data includes an amount of a chemical element in a sample and a plurality of spectroscopic intensities, associated with a corresponding plurality of wavelengths, generated by spectroscopic analysis of the sample by a spectroscopic instrument, and wherein a number of the plurality of wavelengths, associated with the corresponding plurality of spectroscopic intensities, in the calibration data is less than a total number of wavelengths with associated spectroscopic intensities output by the spectroscopic instrument during spectroscopic analysis of the sample; and
generating a calibration model relating a plurality of spectroscopic intensities at a corresponding plurality of wavelengths to an amount of the chemical element in a sample based on training a machine-learning model using the calibration data; and
receiving second calibration data, wherein the second calibration data includes an amount of the chemical element in a second sample and a plurality of spectroscopic intensities, associated with a corresponding plurality of wavelengths, generated by spectroscopic analysis of the second sample by a second spectroscopic instrument, wherein a number of the plurality of wavelengths, associated with the corresponding plurality of spectroscopic intensities, in the second calibration data is less than a total number of wavelengths with associated spectroscopic intensities output by the second spectroscopic instrument during spectroscopic analysis of the sample, and wherein the second spectroscopic instrument is different from the first spectroscopic instrument;
wherein the calibration model is generated based on training the machine-learning model using the second calibration data.

11. The method of claim 10, wherein the first sample has a same material composition as the second sample.

12. The method of claim 10, wherein the first sample has a different material composition than the second sample.

13. The method of claim 10, further comprising:
using the calibration model to output an amount of the chemical element in a sample-under-test based on a plurality of spectroscopic intensities, associated with a corresponding plurality of wavelengths, generated by spectroscopic analysis of the sample-under-test.

14. The method of claim 13, wherein the calibration model is a first calibration model, the spectroscopic instrument is a first spectroscopic instrument, the calibration data is first calibration data, and the method further includes:
receiving second calibration data, wherein the second calibration data includes an amount of the chemical element in a second calibration sample and a plurality of spectroscopic intensities, associated with a corresponding plurality of wavelengths, generated by spectroscopic analysis of the second sample by a second spectroscopic instrument, and wherein the second spectroscopic instrument is different from the first spectroscopic instrument; and
generating a second calibration model relating a plurality of spectroscopic intensities at a corresponding plurality of wavelengths to an amount of the chemical element in a sample by training a machine-learning model, based on the first calibration model, using the second calibration data.

15. The method of claim 14, wherein the second sample has a same material composition as the first sample.

16. The method of claim 14, wherein the second sample has a different material composition than the first sample.

17. The method of claim 14, wherein a number of the plurality of wavelengths, associated with the corresponding plurality of spectroscopic intensities, in the second calibration data is less than a total number of wavelengths with associated spectroscopic intensities output by the second spectroscopic instrument during spectroscopic analysis of the second sample.

18. A method of supporting spectroscopic calibration, comprising:
receiving calibration data, wherein the calibration data includes an amount of a chemical element in a sample and a plurality of spectroscopic intensities, associated with a corresponding plurality of wavelengths, generated by spectroscopic analysis of the sample by a spectroscopic instrument; and
generating a target calibration model for the spectroscopic instrument relating a plurality of spectroscopic intensities at a corresponding plurality of wavelengths to an amount of a chemical element in a sample based on training a machine-learning model, based on a base machine-learning model, using the calibration data for the spectroscopic instrument, wherein the base machine-learning model is trained on calibration data from a plurality of spectroscopic instruments different from the spectroscopic instrument.

19. The method of claim 18, wherein a number of the plurality of wavelengths, associated with the corresponding plurality of spectroscopic intensities, in the calibration data is less than a total number of wavelengths with associated spectroscopic intensities output by the spectroscopic instrument during spectroscopic analysis of the sample.

20. The method of claim 18, further comprising:
using the target calibration model to output an amount of the chemical element in a sample-under-test based on a plurality of spectroscopic intensities, associated with a corresponding plurality of wavelengths, generated by spectroscopic analysis by the spectroscopic instrument of the sample-under-test.
